(19) United States
(12) Patent Application Publication
(10) Pub. No.: US 2017/0273334 A1
(43) Pub. Date: Sep. 28, 2017

(54) Method of Naturally Decomposing Chewing Gum

(71) Applicants: Zoe Kapp, Pacifica, CA (US); Severa Brawn, Pacifica, CA (US); Bella Hoffman, Pacifica, CA (US); Ella Ryan, Pacifica, CA (US); Sophia Woehl, Pacifica, CA (US); Ashley Yoshii, Pacifica, CA (US); Emily Yoshii, Pacifica, CA (US)

(72) Inventors: Zoe Kapp, Pacifica, CA (US); Severa Brawn, Pacifica, CA (US); Bella Hoffman, Pacifica, CA (US); Ella Ryan, Pacifica, CA (US); Sophia Woehl, Pacifica, CA (US); Ashley Yoshii, Pacifica, CA (US); Emily Yoshii, Pacifica, CA (US)

(21) Appl. No.: 15/470,504

(22) Filed: Mar. 27, 2017

Related U.S. Application Data
(60) Provisional application No. 62/313,534, filed on Mar. 25, 2016.

(51) Int. Cl. A23G 4/12

(52) U.S. Cl. CPC A23G 4/123

(57) ABSTRACT

A method naturally decomposing a piece of gum uses a quantity of biological organism infused through a quantity of chewing-gum base. Once the chewing-gum base is masticated by a user, the biological organisms come into contact with the user's saliva and begin to biodegrade the chewing-gum base. This method helps to prevent irresponsible disposal of the chewing-gum base after being removed from the user's mouth.

The current application claims a priority to the U.S. Provisional Patent application Ser. No. 62/313,534 filed on Mar. 25, 2016.

### FIELD OF THE INVENTION

The present invention relates generally to the field of chewing gum. More specifically, the present invention is biodegradable gum with accelerated biodegradation by means of inoculation with a biological organism.

### BACKGROUND OF THE INVENTION

Unlike traditional gum, which can dry into a hard mass that is preserved and resistant to biodegrading organisms, this gum contains them from the beginning. This helps to mitigate the effects of irresponsible disposal, as well as accelerating biodegradation for the gum that makes it into the recycling stream. This is different from other biodegradable gums in that it uses a biological organism, rather than a chemical, to achieve the desired result.

### BRIEF DESCRIPTION OF THE DRAWINGS

FIG. 1 is a block diagram illustrating the system of the present invention.

FIG. 2 is a flowchart illustrating the overall process of the present invention.

### DETAILED DESCRIPTION OF THE INVENTION

All illustrations of the drawings are for the purpose of describing selected versions of the present invention and are not intended to limit the scope of the present invention.

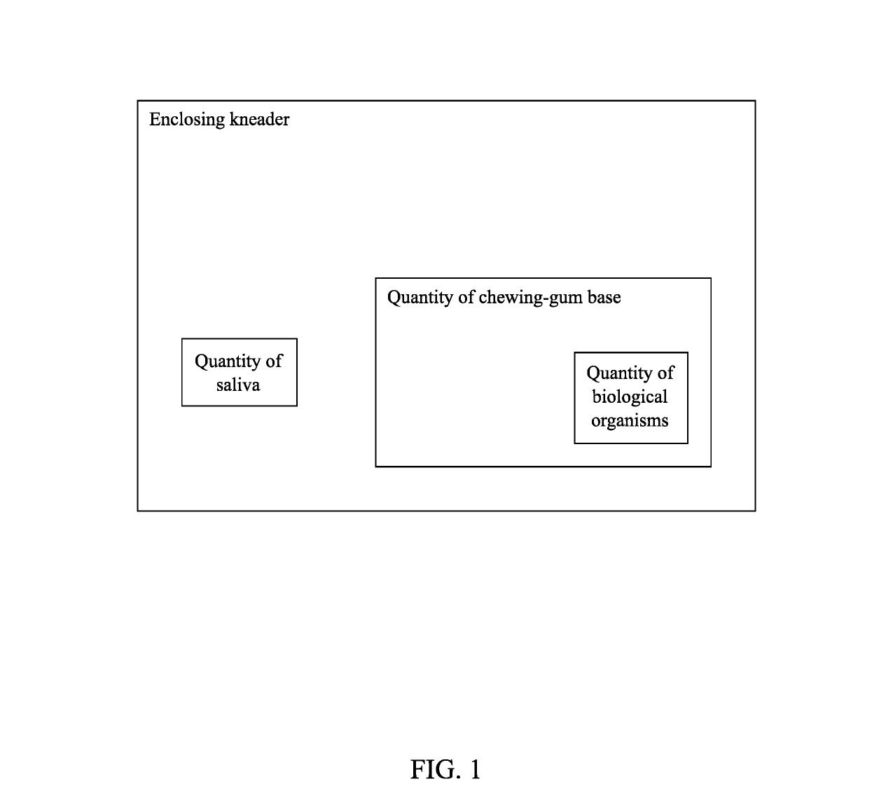

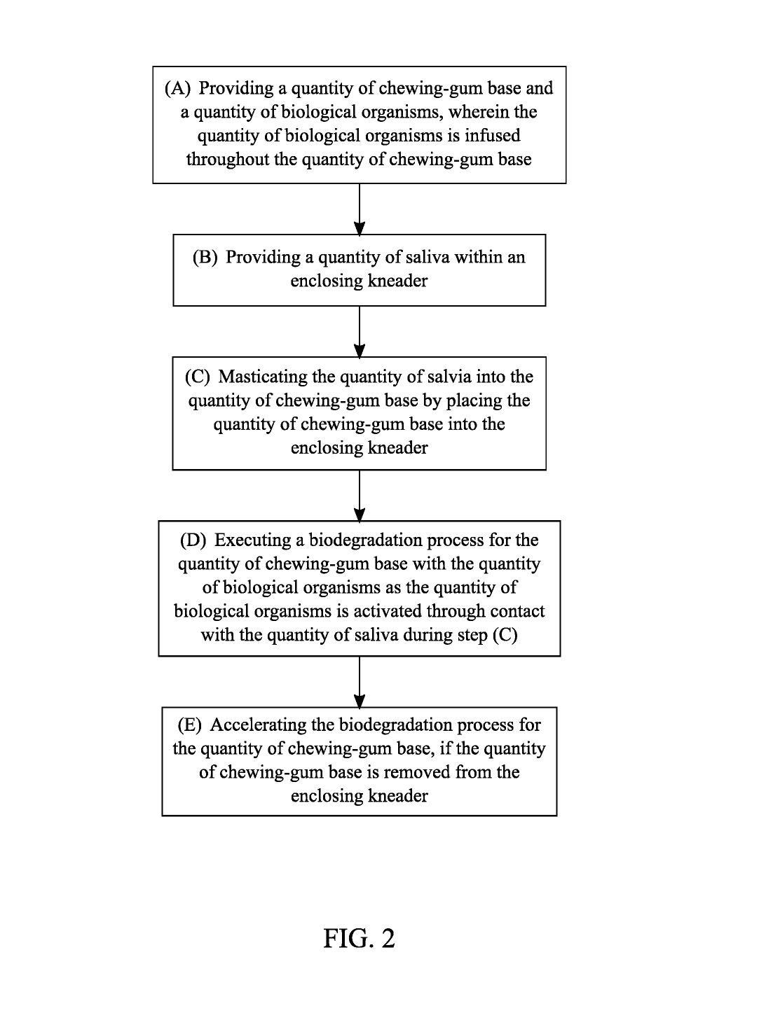

The present invention is a method of naturally decomposing chewing gum so that a piece of gum is not left in a dried-out harden state on an unwanted area. The present invention allows the piece of gum to start decomposing as a user chews on the piece of gum within their mouth. The present invention helps to mitigate the effects of irresponsible disposal and helps to accelerate biodegradation for the piece of gum that makes it into the recycling stream. As can be seen in FIGS. 1 and 2, the present invention enhances a piece of gum by implementing the following components: a quantity of chewing-gum base, a quantity of biological organisms, a quantity of salvia, and an enclosing kneader. The quantity of chewing-gum base allows for the piece of chewing gum to have its kneadable texture. The quantity of chewing-gum base can be composed of other traditional chewing-gum ingredients such as flavorings. For the present invention, the quantity of chewing-gum base is made of, but is not limited to, either a chicle base or a glycerin base. The quantity of biological organisms is used to naturally decompose the quantity of chewing-gum base as the user is chewing on the piece of gum within their mouth. Thus, the quantity of biological organisms is infused throughout the quantity of chewing-gum base (Step A). In addition, the quantity of salvia is used to activate the quantity of biological organisms and consequently needs to be retained within the enclosing kneader (Step B). The enclosing kneader preferably is the user's mouth. The present invention also avoids or limits additional additives for a piece of gum so that the piece of gum is more easily decomposed by the present invention.

As can be seen in FIG. 2, an overall process is followed by the method of the present invention in order to ensure that the present invention is able to naturally decompose chewing gum. The overall process begins by masticating the quantity of salvia into the quantity of chewing-gum base by placing the quantity of chewing-gum base into the enclosing kneader (Step C), which allows the quantity of salvia to be integrated into the quantity of chewing-gum base and to make physical contact with the quantity of biological organisms. This physical contact between the quantity of saliva and the quantity of biological organisms is used to activate the quantity of biological organisms so that the quantity of biological organisms begins to decompose the quantity of chewing-gum base. Thus, the overall process proceeds by executing a biodegradation process for the quantity of chewing-gum base with the quantity of biological organisms (Step D) as the quantity of biological organisms is activated through contact with the quantity of saliva during Step C. The type of biodegradation process that is used to decompose the quantity of chewing-gum base depends of the kind of biological organism that is initially infused into the quantity of chewing-gum base. In addition, if the quantity of chewing-gum base is removed from the enclosing kneader, then the overall process concludes by accelerating the biodegradation process for the quantity of chewing-gum (Step E). The biodegradation process is accelerated for the quantity of chewing-gum base because the quantity of chewing-gum base is aerated outside of the enclosing kneader. Typically, Step E occurs when the user removes the piece of gum from their mouth.

The present invention can use different types of biological organisms in order to naturally decompose chewing gum. One type of biological organism that can be used with the present invention is a type of fungus, which have been traditionally used to ferment food products. Moreover, a preferably type of fungus is aspergillus oryzae, which is more palpable than other kinds of fungus. Aspergillus oryzae has been a popular type of fungus in fermenting food products such as soy sauce, jiang/miso, fermented black soybeans, and grain-based wines (e.g. sake, amazake, and li). Another type of biological organism that can be used with the present invention is a type of bacteria, which would be able to decompose the quantity of chewing-gum base without risking the user's health.

In one embodiment of the present invention, the biodegradation process described in Step D would be executed with the following set of steps in order to naturally decompose chewing gum. This embodiment of the biodegradation process preferably uses aspergillus oryzae or another similar type of fungus as the quantity of biological substance. The first step in this embodiment of the biodegradation process is to produce enzymes with the quantity of biological organisms during Step D. The enzymes allow or assist the present invention in naturally decomposing a piece of gum. The enzymes are produced because the quantity of chewing-gum base typically includes sugars for flavoring. When the quantity of biological organisms consumes the sugars within the quantity of chewing-gum base, the quantity of biological organisms produces those enzymes as byproducts. Some of those enzymes can be, but is not limited to, amylases, proteases, lipases, tanninase, and combinations thereof. The second step in this embodiment of the biodegradation process is to decompose macromolecules of the quantity of chewing-gum base into its constituent parts with those enzymes. For the chewing-gum base, some of its constituent parts can be, but is not limited to, dextrin, glucose, peptides, amino acids, fatty acid chains, and combinations thereof.

In some embodiments of the present invention, a plurality of pockets is integrated throughout the quantity of chewing-gum base. The plurality of pockets is a pragmatic means of housing the quantity of biological organisms within the quantity of chewing-gum base until the user begins knead the quantity of chewing-gum base within their mouth. In addition, the plurality of pockets is integrated throughout the quantity of chewing-gum base so that the quantity of biological organisms is evenly distributed throughout the quantity of chewing-gum base. Consequently, the quantity of biological organisms is able to decompose the entire quantity of chewing-gum base instead of a fraction of the chewing-gum base.

Although the invention has been explained in relation to its preferred embodiment, it is to be understood that many other possible modifications and variations can be made without departing from the spirit and scope of the invention as hereinafter claimed.

What is claimed is:

1. A method of naturally decomposing chewing gum, the method comprises the steps of:
(A) providing a quantity of chewing-gum base and a quantity of biological organisms, wherein the quantity of biological organisms is infused throughout the quantity of chewing-gum base;
(B) providing a quantity of saliva within an enclosing kneader;
(C) masticating the quantity of salvia into the quantity of chewing-gum base by placing the quantity of chewing-gum base into the enclosing kneader;
(D) executing a biodegradation process for the quantity of chewing-gum base with the quantity of biological organisms as the quantity of biological organisms is activated through contact with the quantity of saliva during step (C); and
(E) accelerating the biodegradation process for the quantity of chewing-gum base, if the quantity of chewing-gum base is removed from the enclosing kneader.

2. The method of naturally decomposing chewing gum, the method as claimed in claim 1, the quantity of biological organisms is a type of fungus.

3. The method of naturally decomposing chewing gum, the method as claimed in claim 2, the type of fungus is aspergillus oryzae.

4. The method of naturally decomposing chewing gum, the method as claimed in claim 1, the quantity of biological organisms is a type of bacteria.

5. The method of naturally decomposing chewing gum, the method as claimed in claim 1, the quantity of chewing-gum base is made of a chicle base.

6. The method of naturally decomposing chewing gum, the method as claimed in claim 1, the quantity of chewing-gum base is made of a glycerin base.

7. The method of naturally decomposing chewing gum, the method as claimed in claim 1 comprises the steps of:
producing enzymes with the quantity of biological organisms during step (D); and
decomposing macromolecules of the quantity of chewing-gum base into constituent parts with the enzymes.

8. The method of naturally decomposing chewing gum, the method as claimed in claim 7, the enzymes are selected from a group consisting of: amylases, proteases, lipases, tanninase, and combinations thereof.

9. The method of naturally decomposing chewing gum, the method as claimed in claim 7, the constituent parts are selected from a group consisting of: dextrin, glucose, peptides, amino acids, fatty acid chains, and combinations thereof.

10. The method of naturally decomposing chewing gum, the method as claimed in claim 7 comprises the steps of:
providing sugars within the quantity of chewing-gum base; and
producing the enzymes with the quantity of biological organisms as the quantity of biological organisms consumes the sugars.

11. The method of naturally decomposing chewing gum, the method as claimed in claim 1 comprises the steps of:
providing a plurality of pockets integrated throughout the quantity of chewing-gum base; and
housing the quantity of biological organisms within the plurality of pockets.
